(19) United States
(12) Patent Application Publication
(10) Pub. No.: US 2025/0111337 A1
(43) Pub. Date: Apr. 3, 2025

(54) APPARATUS, METHOD, AND COMPUTER PROGRAM PRODUCT FOR OUTPUTTING A PRIORITIZED ACTIONABLE ITEM INSIGHT INTERFACE COMPONENT TO A PROJECT MANAGEMENT USER INTERFACE

(71) Applicant: ATLASSIAN PTY LTD., Sydney (AU)

(72) Inventors: Natalija Fuksmane, Rose Bay (AU); Kimberlee Tamsin April Tan, Pyrmont (AU); Simon Taylor, Campbelltown (AU); Marcus David Peterson, North Kellyville (AU)

(21) Appl. No.: 18/478,282

(22) Filed: Sep. 29, 2023

(51) Int. Cl. G06Q 10/10; G06F 3/0482; G06F 3/04845

(52) U.S. Cl. CPC G06Q 10/103; G06F 3/0482; G06F 3/04845

(57) ABSTRACT

Apparatus, methods, and computer program products for outputting a prioritized actionable item insight interface component to a project management user interface in a project management and collaboration system are provided. An apparatus may include program code configured to cause the apparatus to detect a prioritized actionable item insight interface component request, access actionable item data, determine a prioritized actionable item suggestion set based at least in part on the actionable item data, the prioritized actionable item suggestion set comprising at least one prioritized actionable item, generate a prioritized actionable item insight interface component comprising the prioritized actionable item suggestion set, and output the prioritized actionable item insight interface component for rendering to a project management user interface of a computing device associated with the prioritized actionable item insight interface component request.

### BACKGROUND

Various methods, apparatuses, and systems provide tools for users to plan, collaborate, execute, and monitor projects and tasks in software development projects. Applicant has identified a number of deficiencies and problems associated with tools for effectively and efficiently providing suggestions and/or recommendations for prioritizing work in existing software development environments, especially in multi-resource software development environments. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

In general, embodiments of the present disclosure provided herein include improved methods, apparatuses, computer program products, and/or the like that are configured for effectively and efficiently outputting, in a project management and collaboration system, a prioritized actionable item insight interface component to a project management user interface, in real-time or near real-time. In accordance with some exemplary embodiments of the present disclosure, an example apparatus is provided for outputting a prioritized actionable item insight interface component to a project management user interface. In some embodiments, the apparatus may comprise at least one processor and at least one memory including program code, the at least one memory and the program code configured to, with the at least one processor, cause the apparatus to at least detect a prioritized actionable item insight interface component request, access actionable item data, determine a prioritized actionable item suggestion set based at least in part on the actionable item data, the prioritized actionable item suggestion set comprising at least one prioritized actionable item, generate a prioritized actionable item insight interface component comprising the prioritized actionable item suggestion set, and output the prioritized actionable item insight interface component for rendering to a project management user interface of a computing device associated with the prioritized actionable item insight interface component request.

In some embodiments, the prioritized actionable item insight interface component request is associated with a project identifier and a team member identifier. In further embodiments, accessing the actionable item data comprises querying an insight component management repository based on at least the project identifier and the team member identifier, and retrieving one or more candidate actionable items associated with the project identifier and the team member identifier. In still some further embodiments, determining the prioritized actionable item suggestion set comprises programmatically determining the at least one prioritized actionable item based on an analysis of the one or more candidate actionable items returned by the query, in an instance wherein the query returns two or more prioritized actionable items, ranking the two or more prioritized actionable items, and generating the prioritized actionable item suggestion set based on the ranked prioritized actionable items.

In some embodiments, programmatically determining the at least one prioritized actionable item is based on a machine learning model. In certain embodiments, the machine learning model is trained using actionable item data.

In some embodiments, the program code is further configured to, with the at least one processor, cause the apparatus to detect a hover user interaction corresponding to a selected prioritized actionable item of the prioritized actionable item suggestion set rendered to the prioritized actionable item insight interface component, identify an actionable item identifier associated with the selected prioritized actionable item corresponding to the detected hover user interaction, generate an informational interface component associated with the actionable item identifier, wherein the informational interface component comprises an actionable item relationship data object associated with the actionable item identifier, and output the informational interface component for rendering to the prioritized actionable item insight interface component in association with the selected prioritized actionable item in real time.

In some embodiments, detecting the prioritized actionable item insight interface component request is in response to user interaction with the project management user interface.

In some embodiments, the program code is further configured to, with the at least one processor, cause the apparatus to cause rendering of a selectable insight interface control elements to the project management user interface, wherein the selectable insight interface control elements is configured for enabling user control of the prioritized actionable item insight interface component. In certain embodiments, the program code is further configured to, with the at least one processor, cause the apparatus to detect a suppress prioritized actionable item insight interface component request, and cause stopping of the rendering of the prioritized actionable item insight interface component. In still some further embodiments, the program code is further configured to, with the at least one processor, cause the apparatus to detect an expand prioritized actionable item insight interface component request subsequent to causing stopping of the rendering of the prioritized actionable item insight interface component, and cause rendering of the prioritized actionable item insight interface component.

In some embodiments, the program code is further configured to, with the at least one processor, cause the apparatus to detect user interaction with an embedded tool link associated with a selected prioritized actionable item, and generate and transmit an access module to the project management user interface, the access module providing access to a software development tool associated with the selected prioritized actionable item. In certain embodiments, the program code is further configured to, with the at least one processor, cause the apparatus to receive a completion notification associated with the selected prioritized actionable item, update the prioritized actionable item suggestion set, wherein updating the prioritized actionable suggestion set comprises removing the selected prioritized actionable item, and cause rendering of the updated prioritized actionable item suggestion set to the prioritized actionable item insight interface component.

In some embodiments, the program code is further configured to, with the at least one processor, cause the apparatus to detect a show more prioritized actionable items request; and cause rendering of additional prioritized actionable items of the prioritized actionable item suggestion set to the prioritized actionable item insight interface component.

In accordance with another exemplary embodiment of the present disclosure, a method for outputting a prioritized actionable item insight interface component to a project management user interface is provided, the method comprising detecting a prioritized actionable item insight interface component request, determining a prioritized actionable item suggestion set, generating a prioritized actionable item insight interface component comprising the prioritized actionable item suggestion set, and outputting the prioritized actionable item insight interface component for rendering to a project management user interface of a computing device associated with the prioritized actionable item insight interface component request.

In some embodiments, the prioritized actionable item insight interface component request is associated with a project identifier and a team member identifier, and wherein determining a prioritized actionable item suggestion set comprises querying an insight component management repository based on at least the project identifier and the team member identifier and retrieving one or more candidate actionable items associated with the project identifier and the team member identifier. In certain embodiments, determining the prioritized actionable item suggestion set comprises programmatically determining at least one prioritized actionable item based on an analysis of the one or more candidate actionable items returned by the query, in an instance wherein the query returns two or more prioritized actionable items, ranking the two or more prioritized actionable items, and generating the prioritized actionable item suggestion set based on the ranked prioritized actionable items.

In some embodiments, the method comprises detecting a hover user interaction corresponding to a selected prioritized actionable item of the prioritized actionable item suggestion set rendered to the prioritized actionable item insight interface component, identifying an actionable item identifier associated with the selected prioritized actionable item corresponding to the detected hover user interaction, generating an informational interface component associated with the actionable item identifier, wherein the informational interface component comprises an actionable item relationship data object associated with the actionable item identifier, and outputting the informational interface component for rendering to the prioritized actionable item insight interface component in association with the selected prioritized actionable item in real time.

In some embodiments, the method comprises detecting user interaction with an embedded tool link associated with a selected prioritized actionable item, generating and transmitting an access module to the project management user interface, the access module providing access to a software development tool associated with the selected prioritized actionable item, receiving a completion notification associated with the selected prioritized actionable item, updating the prioritized actionable item suggestion set, wherein updating the prioritized actionable suggestion set comprises removing the selected prioritized actionable item, and rendering the updated prioritized actionable item suggestion set to the prioritized actionable item insight interface component.

In accordance with another exemplary embodiment of the present disclosure, a computer program product for outputting a prioritized actionable item insight interface component to a project management user interface is provided, the computer program product comprising at least one non-transitory computer-readable storage medium having computer-readable program code portions stored therein, the computer-readable program code portions comprising an executable portion configured to determine a prioritized actionable item suggestion set based at least in part on a detected prioritized actionable item insight interface component request, the prioritized actionable item suggestion set comprising at least one prioritized actionable item, generate a prioritized actionable item insight interface component comprising the prioritized actionable item suggestion set, and output the prioritized actionable item insight interface component for rendering to a project management user interface of a computing device associated with the detected prioritized actionable item insight interface component request.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the figures in accordance with an example embodiment of the present disclosure.

FIG. 1 illustrates an example project management and collaboration system configured to communicate with various client devices in accordance with various example embodiments of the present disclosure.

FIG. 2 depicts a schematic block diagram of example circuitry to perform various operations in accordance with various example embodiments of the present disclosure.

FIGS. 3A and 3B each illustrates an example project management user interface structured in accordance with example embodiments of the present disclosure.

FIGS. 4A and 4B each illustrate an example prioritized actionable item insight interface component structured in accordance with example embodiments of the present disclosure.

FIG. 5A depicts a flowchart diagram illustrating example operations for outputting a prioritized actionable item insight interface component in accordance with an example embodiment of the present disclosure.

FIG. 5B depicts example project management user interfaces illustrating various stages of rendering, suppressing, and expanding a prioritized actionable item insight interface component in a project management user interface in accordance with an example embodiment of the present disclosure.

FIG. 5C illustrates a signal diagram of an example data flow in accordance with an example embodiment of the present disclosure.

FIG. 6 depicts a flowchart diagram illustrating example operations for determining a suggested prioritized actionable item set in accordance with an example embodiment of the present disclosure.

FIG. 7 depicts a flowchart diagram illustrating example operations for outputting an informational interface component for rendering to a prioritized actionable item insight interface component in accordance with an example embodiment of the present disclosure.

FIG. 8 depicts a flowchart diagram illustrating example operations for causing rendering of an updated prioritized actionable item suggestion set in accordance with an example embodiment of the present disclosure.

### DETAILED DESCRIPTION

Example embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details. It should be understood that some, but not all embodiments of the present disclosure are shown and described herein. Indeed, embodiments of the disclosure may be embodied in many different forms, and accordingly this disclosure should not be construed as limited to the embodiments set forth herein; rather, these embodiments are provided so that this disclosure will satisfy applicable legal requirements.

### Overview

Methods, apparatuses, systems, and computer program products are provided in accordance with example embodiments of the present disclosure in order to address technical problems associated with enabling efficient and reliable generation and provision of a contextually relevant prioritized actionable item insight interface component in a project management and collaboration system, which further reduces computational load and provides a low latency user experience.

A project management and collaboration system (e.g., Jira® by Atlassian) enables a user or group of users to plan, track, organize, schedule, address, execute, monitor and/or otherwise manage one or more software development projects. In such agile software development projects, it is desirable for one or more individual contributors (e.g., team members) to be assigned smaller sub-projects or work assignments in a de-centralized environment in a series of iterations to allow for continuous evaluation and improved response to unanticipated changes experienced during the development project as compared to a linear project. An important responsibility for individual contributors in such an agile software development project is being able to identify and pick up the next work item on which to focus. However, as software development projects become more and more complex this responsibility has become increasingly difficult as it may not be readily apparent to an individual contributor what specifically they should be working on next. This problem is only exacerbated by the wide sprawl and number of resources (e.g., software development operations tools or applications) available to and utilized by a software development team in a multi-resource software development environment. In a multi-resource software development environment, each unit of work may be associated with one or more resources (e.g., software development operations tools or applications) configured to interact with one other. For example, a software development team may utilize Jira® by Atlassian for project management and collaboration and may utilize GitHub® by Atlassian for code execution, release, and revision control. A software development team may use other resources (e.g., Bitbucket® by Atlassian, Confluence® by Atlassian, etc.) for facilitating various other tasks and/or sub-tasks (e.g., source code management, continuous integration, continuous delivery, design, security, product security, etc.) associated with the software development. Every additional resource or tool increases the likelihood of work fragmentation, context switching, extended wait times, and data silos. Such fragmented tool chains, inconsistent data contracts across 1P (first-party) and 3P (third-party) providers, and data silos create bottlenecks, inefficiencies, interruptions, and gaps across the software development lifecycle.

In one example, an individual contributor (e.g., a team member) working on a particular software development project may find it challenging to identify the next task (e.g., actionable item) to work on. Said differently, while a team member might identify a next obvious task to complete, they might miss a less obvious task that is of higher priority and/or if completed, would improve the overall efficiency of the particular software development project. Still further, in existing systems, users must manually check issues at the respective resource or tool in order to assess priority, severity, frequency, etc. and determine the next task on which to work. This can be time consuming and may be resource intensive. In this regard, the inventors have determined that it is desirable to be able to programmatically identify the next best task (e.g., prioritized actionable item) and surface such prioritized actionable item(s) to an integrated project management user interface (e.g., the board view of the project management user interface), thereby providing prioritized actionable item insight recommendations to the user in real time or near real time.

Such embedded prioritized actionable item insight recommendations may reduce bottlenecks and improve team efficiency (e.g., accelerate the pace of an entire team's delivery), developer experience, and cycle time (e.g., the time spent working on an issue) by dynamically exposing such prioritized actionable item insights to an individual contributor at a key moment in the software development lifecycle, i.e., when the individual contributor is viewing their existing work to be done and determining the next piece of work to pick up. That is, example prioritized actionable item insight interface components of the present disclosure optimize the flow of work by minimizing distractions and providing individual contributors with an easy way to find out, of all the possible things they could be working on, what should be their top focus.

Embodiments of the present disclosure are not limited to the individual contributor or team member. For example, teams and/or team leads may benefit from such exposure to programmatically determined prioritized actionable item insights. In a non-limiting use case, a team lead is often confronted by lack of visibility to, for example, blocked work that needs escalation, actions from Retros that need to be followed through, and incidents coming from operations that need to be mitigated. Embodiments of the present disclosure are configured to programmatically determine prioritization of such actionable items relevant to the team and/or team leader and surface such actionable items to the team and/or team leader (e.g., associated with planning a future sprint for multiple contributors associated with the sprint team). Similarly, designers may also benefit from such exposure to programmatically determined prioritized actionable item insights. For example, a designer may be unaware of pending requirement(s) that are blocking developers from progressing or may be missing request for clarification from developers that leaves comments on design files. Embodiments of the present disclosure may be configured to programmatically determine prioritization of such actionable items and surface such actionable items to the designer.

Determining such recommendations that are aligned to, for example, user role, context, team topology, point in time, etc., presents technological challenges in such complex multi-resource software development environments. Accordingly, the inventors have further determined that because the multiple resources and varied data outputted in an agile project management environment is not necessarily comparable nor are the key indicators necessarily selectable by a human, it would be advantageous to leverage artificial intelligence and train a machine learning model with such a dissimilar aggregate of data in order to identify prioritized actionable items and/or determine at least a suggested prioritized actionable item set. The determined suggested prioritized actionable item set (or portion thereof) is included in the prioritized actionable item insight component which is output for rendering to a project management user interface for display on a client device. The machine learning model thereby informs the prioritized actionable item insight interface component, in near real-time or real-time, to provide insight to the individual contributor and/or team. These characteristics as well as additional features, functions, and details are described below. Similarly, corresponding and additional embodiments are also described below.

### Definitions

The following explanations of terms are provided to better describe the present disclosure and to guide those of ordinary skill in the art in the practice of the present disclosure.

As used herein, the term “project management and collaboration system” refers to the software platform(s) and associated hardware configured to support and maintain a plurality of projects, workflows, and all associated functionality. For example, a project management and collaboration system may comprise a software product such as Jira® by Atlassian. Example project management and collaboration systems comprise supporting server(s) and repositor(ies), and in some embodiments, are further configured to engage with internal resources, external resources, internal applications, and/or external applications.

The term “project management server” refers to a software platform and associated hardware that is configured to, inter alia, manage the various prioritized actionable item insight interface components and associated functionality of the project management and collaboration system. For example, the project management server is configured to generate and/or output prioritized actionable item insight interface components, manage prioritized actionable item insight interface component requests, identify actionable item candidate data objects, determine prioritized actionable item suggestion sets, generate, manage, and/or update prioritized actionable item insight interface components, and/or continually refine one or more machine learning models (e.g., based on user feedback data objects), among other things. The project management server is accessible via one or more computing devices, is configured to receive various requests (e.g., prioritized actionable item insight interface component request(s), request(s) for access to the underlying tool, expand prioritized actionable item insight interface component request(s), suppress prioritized actionable item insight interface component request(s), and/or the like), and access one or more data repositories (e.g., insight component management repository 215). The functionality of the project management server may be provided via a single server or collection of servers having a common functionality, or the functionality of the project management server may be segmented among a plurality of servers or collections of servers (e.g., a cloud networking environment, microservices, and/or the like) performing subsets of the described functionality of the project management server.

The term “project management user interface” refers to a graphical user interface of a project management and collaboration system that is configured to enable users to view and engage with one or more project management workspaces or views. A project management user interface is rendered to a client device based on data and instructions provided by the project management and collaboration system (e.g., project management server). In some embodiments, such data and instructions are facilitated by a dedicated software application running on the client device. In other embodiments, such data and instructions are provided through a web browser running on the client device. Non-limiting examples of a project management user interface include a board view interface associated with an ongoing or active development unit (e.g., software development project), a backlog view interface associated with planning a future development unit (e.g., a sprint), a deployments view interface associated with tracking of completed or deployed development units, and a road maps view interface associated with tracking development units and progress across multiple teams. For example, in a non-limiting example use case, the project management user interface may be associated with a backlog view interface associated with planning a sprint and the generation and determination of the corresponding prioritized actionable item insight interface component, prioritized actionable item suggestion set, and prioritized actionable item(s) may be based on the sprint team and/or team leader associated with the sprint in order to surface prioritized actionable item(s) related to the sprint team (e.g., not just an individual contributor).

The terms “project management application” or “project management app” refer to a dedicated software program, application, platform, service, web browser, or computer-executable application software programmed or configured to run on a client device which provides the user (e.g., an individual contributor, a team member, a team, a team leader, a designer, etc.) access to the project management and collaboration system and its associated functionality. In some embodiments, the project management application may include hardware, software, or combinations thereof operating remotely (e.g., on a server). In some embodiments, the project management application is designed to execute on mobile devices, such as tablets or smartphones. For example, in certain embodiments, an app is provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

The term “development unit” refers to a fundamental work development component, part, event, and the like in a project development cycle within a project management and collaboration system. In some embodiments, a development unit comprises one or more smaller development units or increments. For example, to provide context, a large development unit, such as a project, is delivered in one or more small increments, such as sprint(s). Non-limiting examples of a development unit include a project, a sprint, a user story, an epic, an issue, a task, a work item, a work unit (e.g., a unit or version of code), an iteration, a Kanban, and/or the like.

As used herein, the term “development unit identifier” refers to one or more items of data by which a development unit may be uniquely identified within a project management and collaboration system. A non-limiting example of a development unit identifier is a “project identifier”. The terms “project identifier” or “project ID” refer to one or more items of data by which software development project may be uniquely identified within a project management and collaboration system. For example, a development unit identifier or project identifier may comprise one or more of ASCII text, encryption keys, identification certificates, a pointer, an IP address, a URL, a MAC address, a memory address, or other unique identifier, or combinations thereof.

The terms “actionable item”, “work item”, “issue object,” “issue,” and similar terms as used herein can be used interchangeably to refer to a work item to be completed in a project development life cycle, such as a software development life cycle. For example, an actionable item may represent an individual work item such as a software development task. Actionable items may also refer to features, user requirements, software bugs, and other items that represent work.

As used herein, the term “actionable item identifier” refers to one or more items of data by which an actionable item may be uniquely identified within a project management and collaboration system. A non-limiting example of actionable item identifier is a “task identifier”. For example, an actionable item identifier or task identifier may comprise one or more of ASCII text, encryption keys, identification certificates, a pointer, an IP address, a URL, a MAC address, a memory address, or other unique identifier, or combinations thereof.

As used herein, the term “user identifier” refers to one or more items of data by which a user, such as an individual contributor, team member, team leader, etc., may be uniquely identified within a project management and collaboration system. Non-limiting examples of a user identifier include a “team member identifier” or “team member ID”. For example, a user identifier or team member identifier may comprise one or more of American Standard Code for Information Interchange (ASCII) text, encryption keys, identification certificates, a pointer, an Internet Protocol (IP) address, a URL, a MAC address, a memory address, or other unique identifier, or combinations thereof.

The terms “team identifier” or “team ID” refer to one or more items of data by which a team comprising one or more team members may be uniquely identified within a project management and collaboration system. For example, a project identifier may comprise one or more of ASCII text, encryption keys, identification certificates, a pointer, an IP address, a URL, a MAC address, a memory address, or other unique identifier, or combinations.

The term “prioritized actionable item insight interface component” refers to a user interface element that is rendered to, or as a portion of, a project management user interface in a project management and collaboration system and is configured to display one or more prioritized actionable items (e.g., at least a portion of a prioritized actionable item suggestion set) associated with a selected team member. In some embodiments, a prioritized actionable item insight interface component is configured to be displayed in association with an ongoing or active project (e.g., in association with a board view of a project management user interface).

In some embodiments, the prioritized actionable item insight interface component is configured to be rendered to a project management user interface in a selected one of two or more states or formats. For example, in some embodiments, a prioritized actionable item insight interface component is rendered to a project management user interface in a first or expanded format in response to user interaction with an avatar or other selectable element (e.g., selectable insight interface control element) corresponding to and/or associated with a prioritized actionable item insight interface component request. For example, the project management user interface may be caused to render a selectable insight interface control element in association with a user avatar, the selectable insight interface control elements enabling further or additional control of the prioritized actionable item insight interface component.

In certain embodiments, the prioritized actionable item insight interface component is rendered (or effectively, stopped rendering) to the project management user interface in a second or collapsed format in response to further user interaction with the avatar, selectable insight interface control element associated with the avatar, or a selectable “close panel” element (“x”) corresponding to or associated with a suppress prioritized actionable item insight interface component request. In still further embodiments, the prioritized actionable item insight interface component is configured to be rendered (e.g., re-rendered) to the first or expanded format in response to further user interaction with the avatar or selectable insight interface control element associated with the avatar.

The term “prioritized actionable item insight interface component request” refers to an electrically generated digital object created by a computing device that indicates that a user (e.g., an individual contributor, a team member, etc.) has provided an input comprising a request to generate and display a prioritized actionable item insight interface component. In some embodiments, the prioritized actionable item insight interface component is associated with a development unit identifier (e.g., a project identifier), a user identifier (e.g., a team identifier), a team identifier, and/or the like. A prioritized actionable item insight interface component request may be represented via a temporary code that notifies a recipient (e.g., a server) that a user (e.g., an individual contributor, a team member, etc.) has made the request. To provide further context, a prioritized actionable item insight interface component request is generated in response to a user interaction with a computing device wherein a user causes the computing device to generate a prioritized actionable item insight interface component request. For example, in some embodiments, the user interacts with, for example, a specific prioritized actionable item insight interface component actuator button (e.g., such as an avatar of the user) rendered on a visual display of the computing device.

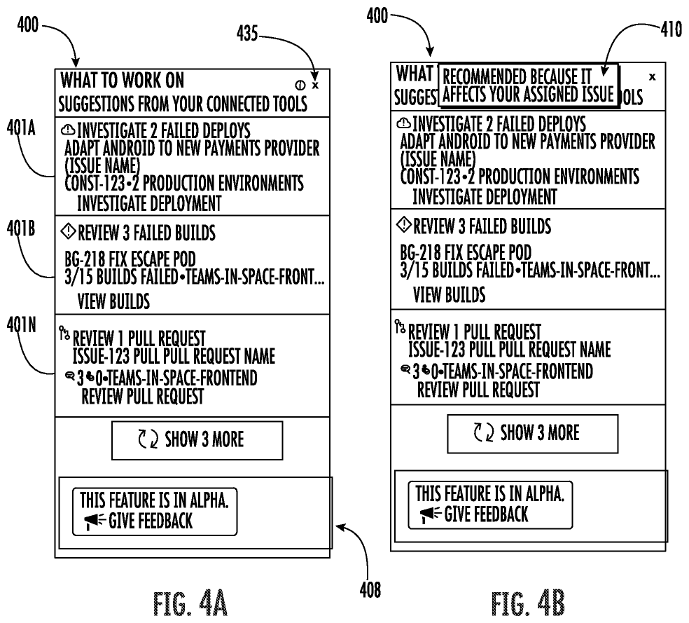

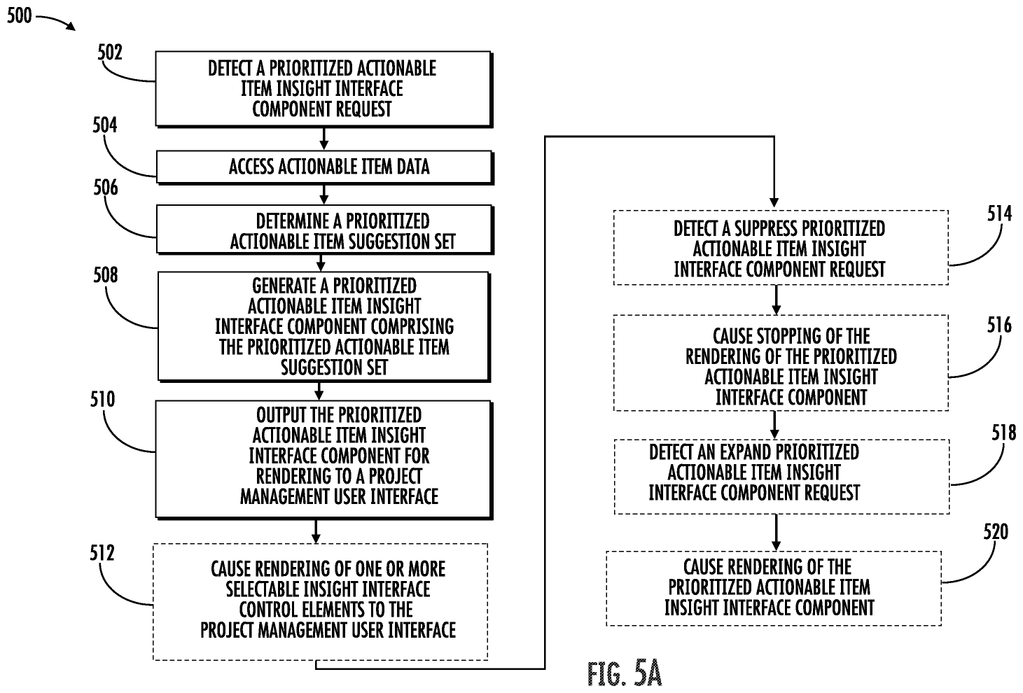

The term “informational interface component” refers to a user interface element that is rendered to, or as a portion of, a project management user interface in a project management and collaboration system and is configured to display additional information associated with an insight component. For example, in some embodiments, an informational interface component is configured to be rendered to a project management user interface in association with a selected prioritized actionable item insight interface component when a hover user interaction is detected in association with a portion of the prioritized actionable item insight interface component. For example, as depicted in FIG. 4B, in response to detecting a hover user interaction by the user (e.g., detecting pointer) in association with a first one of the identified prioritized actionable items, additional information associated with the identified prioritized actionable item, in particular, an actionable item relationship data object (e.g., underlying basis for the identified prioritized actionable item and/or the like) is rendered via an informational interface component.

The term “user feedback data object” refers to a data object that is generated by a client computing device and transmitted to the project management server. The user feedback data objects are generated based on end-user interactions with the client computing device in relation to a prioritized actionable item insight interface component. For example, a user interface displayed by the client computing device may enable end-users to rate and/or otherwise provide feedback on, for example, the relevancy of a prioritized actionable item and/or a prioritized actionable item suggestion set, and the user-provided ratings may then be used to determine user feedback data objects. In some embodiments, the user feedback data objects are used to retrain at least one machine learning model.

The terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The term “client device,” “computing device,” “network device,” “computer,” “user equipment,” and similar terms may be used interchangeably to refer to computer hardware and/or software that is configured to access a service made available by a server (e.g., project management server). The server is often (but not always) on another computer system, in which case the client device accesses the service by way of a network. Client devices may include, without limitation, smart phones, tablet computers, laptop computers, wearables, personal computers, enterprise computers, and the like.

The term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

The terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked or remote computing devices, such as, but not limited to, client devices. Non-limiting examples of an application comprise project management, workflow engines, software incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The term “database,” “resource,” and/or similar terms used herein interchangeable may refer to a collection of records or data that is stored in a computer-readable storage medium using one or more database types. The term “database type” may refer to a type of database, such as a hierarchical database, network database, relational database (e.g., Aurora, RDS), entity-relationship database, object database (e.g., S3), document database, semantic database, graph database, noSql database (e.g., DynamoDB), and/or the like. The term “insight component management repository” refers to a location, such as a database stored on a memory device, which is accessible by one or more computing devices for retrieval and storage of data associated with prioritized actionable item insight interface components. For example, the insight component management repository includes one or more of actionable item identifier(s), team member identifier(s), project identifier(s), prioritized actionable item suggestion set(s), user feedback data object(s), and/or the like. The insight component management repository may be a dedicated device and/or a part of a larger repository. The insight component management repository may be dynamically updated or be static.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the terms “illustrative,” “example,” “exemplary” and the like are used to mean “serving as an example, instance, or illustration” with no indication of quality level. Any implementation described herein as “exemplary” or “example” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “plurality” refers to two or more items.

The term “set” refers to a collection of one or more items.

The term “or” is used herein in both the alternative and conjunctive sense, unless otherwise indicated.

### Example Systems and Apparatuses of the Disclosure

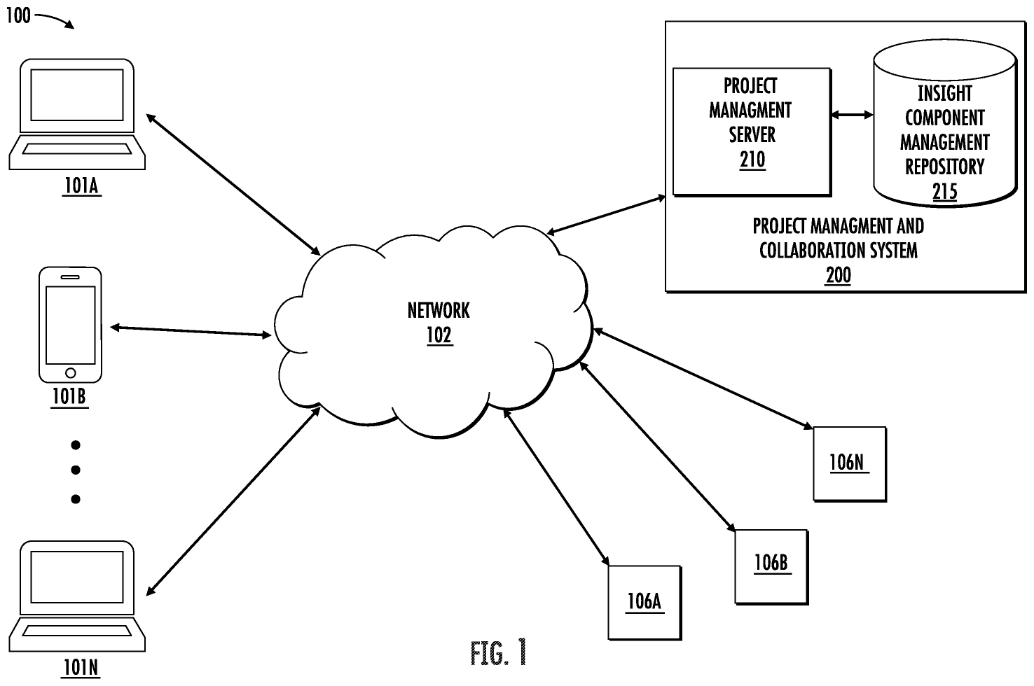

Referring now to FIG. 1, an example computing system 100 architecture within which some embodiments of the present disclosure operate is illustrated. The example computing system 100 comprises one or more software development tools 106A-106N, project management and collaboration system 200, and a plurality of client devices 101A-101N, each communicatively connected through a communications network 102. Accordingly, user(s) (e.g., team member, individual contributor, team leader, designer, etc.) may access the project management and collaboration system 200 via the communications network 102 using one or more of client devices 101A-101N. Project management and collaboration system 200 may comprise a project management server 210 in communication with at least one repository, such as insight component management repository 215. Such repository (ies) may be hosted by the project management server 210 or otherwise hosted by devices in communication with the project management server 210.

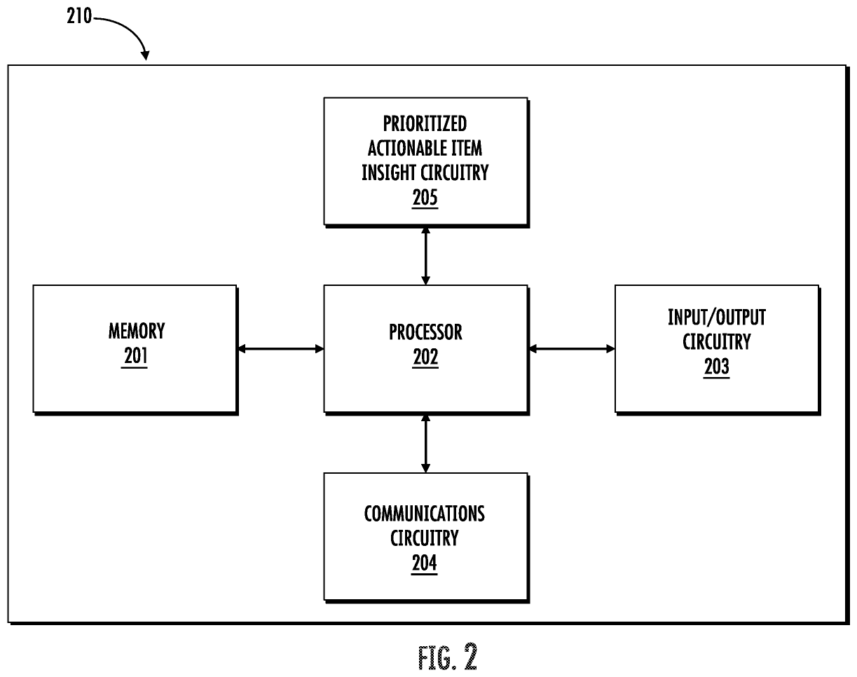

Project management server 210 may include circuitry, networked processors, or the like configured to perform some or all of the project management server-based processes described herein and may be any suitable network server and/or other type of processing device. In some embodiments, project management server 210 may determine and transmit commands and instructions for rendering one or more project management user interfaces to client devices 101A-101N, using data from, for example, insight component management repository 215. In this regard, the project management server 210 may be embodied by any of a variety of devices, for example, the project management server 210 may be embodied as a computer or a plurality of computers. For example, project management server 210 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, project management server 210 may be located remotely from the insight component management repository 215, although in other embodiments, the project management server 210 may comprise the insight component management repository 215. The project management server 210 may, in some embodiments, comprise several servers or computing devices performing interconnected and/or distributed functions. Despite the many arrangements contemplated herein, project management server 210 is shown and described herein as a single computing device to avoid unnecessarily overcomplicating the disclosure.

Project management server 210 can communicate with one or more client devices 101A-101N via communications network 102. Communications network 102 may include any one or more wired and/or wireless communication networks including, for example, a wired or wireless local area network (LAN), personal area network (PAN), metropolitan area network (MAN), wide area network (WAN), or the like, as well as any hardware, software and/or firmware required for implementing the one or more networks (e.g., network routers, switches, hubs, etc.). For example, communications network 102 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the communications network 102 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the project management and collaboration system 200.

Insight component management repository 215 may be stored by any suitable storage device configured to store some or all of the information described herein (e.g., memory 201 of the project management server 210 or a separate memory system separate from the project management server 210, such as one or more database systems, backend data servers, network databases, cloud storage devices, or the like provided by another device (e.g., online application or 3^{rd} party provider), such as a Network Attached Storage (NAS) device or devices, or as a separate database server or servers. Insight component management repository 215 may comprise data received from the project management server 210 (e.g., via a memory 201 and/or processor(s) 202), and the corresponding storage device may thus store this data. Insight component management repository 215 includes information accessed and stored by the project management server 210 to facilitate the operations of the project management and collaboration system 200. As such, insight component management repository 215 may include, for example, without limitation, actionable item identifiers, team member identifiers, team identifiers, project identifiers, actionable item data, and/or the like.

Software development tools 106A-106N may be any one or more underlying software development tools (e.g., Bitbucket®, etc.) from which actionable items may originate.

The client devices 101A-101N may be implemented as any computing device as defined above. Electronic data received by the project management server 210 from the client devices 101A-101N may be provided in various forms and via various methods. For example, the client devices 101A-101N may include desktop computers, laptop computers, smartphones, netbooks, tablet computers, wearables, and/or other networked device, that may be used for any suitable purpose in addition to presenting the project management user interface to a user (e.g., planning user) and otherwise providing access to the project management and collaboration system 200. The depiction in FIG. 2 of “N” client devices is merely for illustration purposes. According to some embodiments, the client devices 101A-101N may be configured to display an interface on a display of the client device for viewing, creating, editing, and/or otherwise interacting with at least one project management user interface, which may be provided by the project management and collaboration system 200. According to further embodiments, the client devices 101A-101N may be configured to generate and/or display a prioritized actionable item insight interface component and/or the like.

In embodiments where a client device 101A-101N is a mobile device, such as a smartphone or tablet, the client device 101A-101N may execute an “app” to interact with the project management and collaboration system 200. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. The mobile operating systems named above each provide frameworks for interacting with, for example, wired and wireless network interfaces, user contacts, and other applications. Communication with hardware and software modules executing outside of the app is typically provided via application programming interfaces (APIs) provided by the mobile device operating system. Additionally, or alternatively, the client device 101A-101N may interact with the project management and collaboration system 200 via a web browser. As yet another example, the client devices 101A-101N may include various hardware or firmware designed to interface with the project management and collaboration system 200.

### Example Apparatus for Implementing Embodiments of the Present Disclosure

FIG. 2 illustrates an example project management server 210 in accordance with at least some example embodiments of the present disclosure. In accordance with some example embodiments, project management server 210 may include various components, modules, circuitries, or means, some or all of which may be also or instead be included in one or more client device(s) 101A-101N. In accordance with some example embodiments, project management server 210 may be configured, using one or more of the sets of circuitry embodying memory 201, processor 202, input/output circuitry 203, communications circuitry 204, and/or prioritized actionable item insight circuitry 205 to execute and perform the operations described herein. In some embodiments, prioritized actionable item insight circuitry 205 is included in project management server 210 and/or client device 101A, the circuitry configured to facilitate the functionality discussed herein regarding generating prioritized actionable item insight interface component(s) and/or the like. It will be appreciated that while various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

Although the use of the term “circuitry” as used herein with respect to components 201-205 are described in some cases with respect to functional limitations, it should be understood that the particular implementations necessarily include the use of particular hardware configured to perform the functions associated with the respective circuitry as described herein. It should also be understood that certain of these components 201-205 may include similar or common hardware. For example, two sets of circuitry may both leverage use of the same processor(s), network interface(s), storage medium(s), and/or the like, to perform their associated functions, such that duplicate hardware is not required for each set of circuitry. The use of the term “circuitry” with respect to components of the apparatuses described herein should therefore be understood to include particular hardware configured to perform the functions associated with the respective components or particular circuitry as described herein.

The term “circuitry” should also be understood, in some embodiments, to include software for configuring the hardware. For example, in some embodiments, “circuitry” may include processing circuitry, storage media, network interfaces, input/output devices, and the like. In some embodiments, such as in examples where circuitry is included with project management server 210, other elements of the project management server 210 may provide or supplement the functionality of particular circuitry. For example, the processor 202 may provide processing functionality, the memory 201 may provide storage functionality, the communications circuitry 204 may provide network interface functionality, and the like.

In some embodiments, the processor 202 (and/or co-processor or any other processing circuitry assisting or otherwise associated with the processor) may be in communication with the memory 201 via a bus for passing information among components of, for example, project management server 210. The memory 201 is non-transitory and may include, for example, one or more volatile and/or non-volatile memories, or some combination thereof. In other words, for example, the memory 201 may be an electronic storage device (e.g., a computer readable storage medium). The memory 201 may be configured to store information, data, content, applications, instructions, or the like, for enabling an apparatus, e.g., project management server 210 to carry out various functions in accordance with example embodiments of the present disclosure.

Although illustrated in FIG. 2 as a single memory, memory 201 may comprise a plurality of memory components. The plurality of memory components may be embodied on a single computing device or distributed across a plurality of computing devices. In various embodiments, memory 201 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 201 may be configured to store information, data, applications, instructions, or the like for enabling project management server 210 to carry out various functions in accordance with example embodiments discussed herein. For example, in at least some embodiments, memory 201 is configured to buffer data for processing by processor 202. Additionally or alternatively, in at least some embodiments, memory 201 is configured to store program instructions for execution by processor 202. Memory 201 may store information in the form of static and/or dynamic information. This stored information may be stored and/or used by project management server 210 during the course of performing its functionalities.

Processor 202 may be embodied in a number of different ways and may, for example, include one or more processing devices configured to perform independently. Additionally or alternatively, processor 202 may include one or more processors configured in tandem via a bus to enable independent execution of instructions, pipelining, and/or multithreading. Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, processor 202 comprises a plurality of processors. The plurality of processors may be embodied on a single computing device or may be distributed across a plurality of such devices collectively configured to function as project management server 210. The plurality of processors may be in operative communication with each other and may be collectively configured to perform one or more functionalities of project management server 210 as described herein.

In an example embodiment, processor 202 is configured to execute instructions stored in the memory 201 or otherwise accessible to processor 202. Alternatively or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure processor 202 to perform one or more algorithms and/or operations described herein when the instructions are executed. For example, these instructions, when executed by processor 202, may cause project management server 210 to perform one or more of the functionalities of project management server 210 as described herein.

In some embodiments, input/output circuitry 203 may, in turn, be in communication with processor 202 to provide an audible, visual, mechanical, or other output and/or, in some embodiments, to receive an indication of an input. In that sense, input/output circuitry 203 may include means for performing analog-to-digital and/or digital-to-analog data conversions. Input/output circuitry 203 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output circuitry 203 may comprise a user interface (e.g., a project management user interface, a development unit performance summary insight interface component, a development unit performance detailed insight interface component etc.) and may comprise a web user interface, a mobile application, a kiosk, or the like. The processor 202 and/or user interface circuitry comprising the processor 202 may be configured to control one or more functions of a display or one or more user interface elements through computer program instructions (e.g., software and/or firmware) stored on a memory accessible to the processor 202 (e.g., memory 201, and/or the like). In some embodiments, aspects of input/output circuitry 203 in project management server 210 may be reduced when implemented also or instead as an end-user machine or other type of device designed for complex user interactions (i.e., client device 101). In some embodiments (like other components discussed herein), input/output circuitry 203 may even be eliminated from project management server 210. Alternatively, at least some aspects of input/output circuitry 203 may be embodied on an apparatus used by a team member or individual contributor that is in communication with project management server 210. Input/output circuitry 203 may be in communication with memory 201, communications circuitry 204, and/or any other component(s), such as via a bus. Although more than one input/output circuitry and/or other component can be included in project management server 210, only one is shown in FIG. 2 to avoid overcomplicating the disclosure (e.g., like the other components discussed herein).

Communications circuitry 204 may be any means such as a device or circuitry embodied in either hardware or a combination of hardware and software that is configured to receive and/or transmit data from/to a network and/or any other device, circuitry, or module in communication with project management server 210. In this regard, the communications circuitry 204 may include, for example, a network interface for enabling communications with a wired or wireless communication network. Communications circuitry 204 may be configured to receive and/or transmit any data that may be stored by memory 201 using any protocol that may be used for communications between computing devices. For example, the communications circuitry 204 may include one or more network interface cards, antennae, transmitters, receivers, buses, switches, routers, modems, and supporting hardware and/or software, and/or firmware/software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by project management server 210 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications circuitry 204 may additionally or alternatively be in communication with the memory 201, input/output circuitry 203 and/or any other component of project management server 210, such as via a bus.

In some embodiments, prioritized actionable item insight circuitry 205 may also or instead be included and configured to perform the functionality discussed herein related to providing a prioritized actionable item insight interface component. Prioritized actionable item insight circuitry 205 includes hardware components and/or software configured to support development unit insight-related functionality, features, and/or services of the project management server 210. In some embodiments, prioritized actionable item insight circuitry 205 includes hardware components and/or software configured to support a machine learning model to provide prioritized actionable item insight-related functionality, features, and/or services of the project management server 210. The prioritized actionable item insight circuitry 205 may utilize processing circuitry, such as the processor 202, to perform its corresponding operations, and may utilize memory 201 to store collected information. The prioritized actionable item insight circuitry 205 may send and/or receive data from insight component management repository 215. In some implementations, the sent and/or received data may include identifier(s) (e.g., actionable item identifier, team identifier, team member identifier, project identifier and/or the like), actionable item data, user feedback data objects, and associated data that is configured for association with, for example, generating prioritized actionable item insight interface component(s) (e.g., prioritized actionable item insight interface component). It should also be appreciated that, in some embodiments, the prioritized actionable item insight circuitry 205 may include a separate processor, specially configured field programmable gate array (FPGA), or application specific interface circuit (ASIC) to perform its corresponding functions. For example, in some embodiments, some or all of the functionality of prioritized actionable item insight circuitry 205 may be performed by processor 202. In this regard, some or all of the example processes and algorithms discussed herein can be performed by at least one processor 202 and/or prioritized actionable item insight circuitry 205. For example, non-transitory computer readable storage media can be configured to store firmware, one or more application programs, and/or other software, which include instructions and other computer-readable program code portions that can be executed to control processors of the components of project management server 210 to implement various operations, including the examples shown herein. As such, a series of computer-readable program code portions may be embodied in one or more computer program products and can be used, with a device, project management server 210, database, and/or other programmable apparatus, to produce the machine-implemented processes discussed herein. It is also noted that all or some of the information discussed herein can be based on data that is received, generated and/or maintained by one or more components of the project management server 210. In some embodiments, one or more external systems (such as a remote cloud computing and/or data storage system) may also be leveraged to provide at least some of the functionality discussed herein.

As described above and as will be appreciated based on this disclosure, embodiments of the present disclosure may be configured as systems, methods, apparatuses, computing devices, personal computers, servers, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions embodied in the computer-readable storage medium (e.g., computer software stored on a hardware device). Any suitable computer-readable storage medium may be utilized including non-transitory hard disks, CD-ROMs, flash memory, optical storage devices, or magnetic storage devices.

As will be appreciated, any such computer program instructions and/or other type of code may be loaded onto a computer, processor, or other programmable apparatus's circuitry to produce a machine, such that the computer, processor, or other programmable circuitry that execute the code on the machine creates the means for implementing various functions, including those described herein in connection with the components of project management server 210.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a planning user interacting with the client device). Information/data generated at the client device (e.g., a result of the user interaction) can be received from the client device at the server.

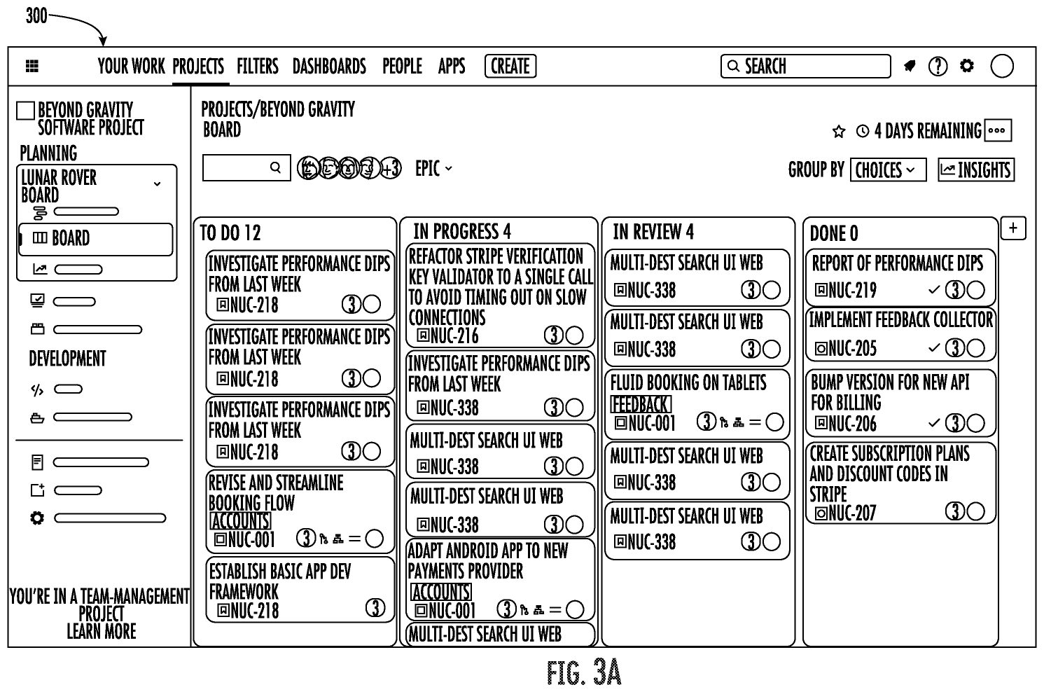

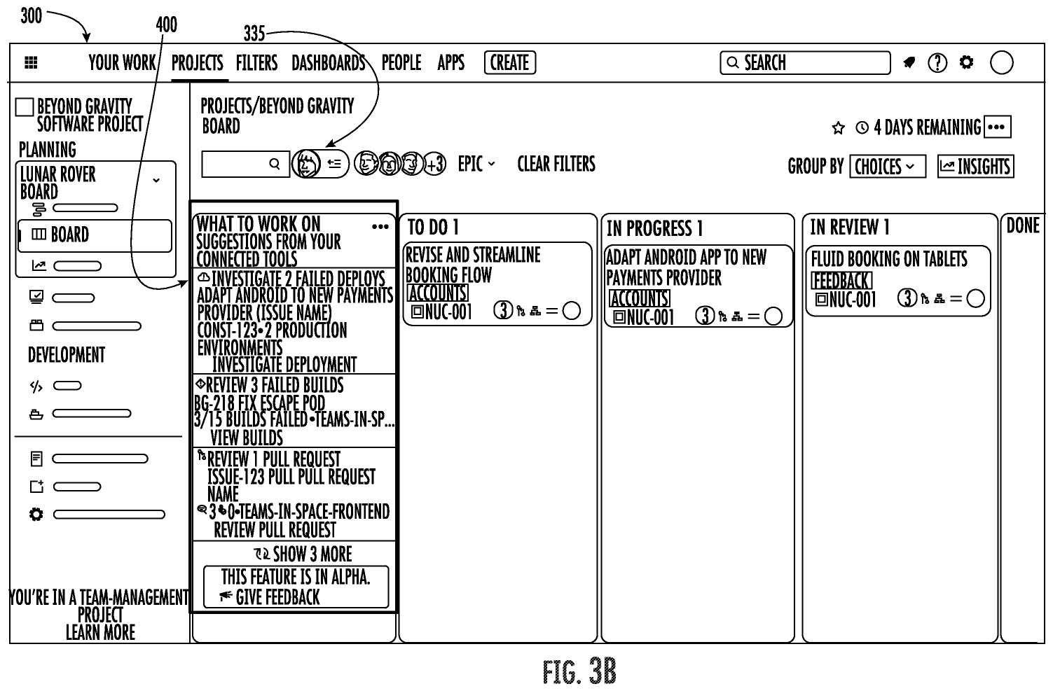

In various embodiments of the present disclosure, an apparatus (e.g., project management server 210) is configured to manage a project management user interface of a project management and collaboration system 200. FIGS. 3A and 3B illustrate an example project management user interface 300 structured in accordance with various embodiments of the subject disclosure. In some embodiments, the apparatus (e.g., project management server 210) causes rendering of the project management user interface 300 to a visual display of a computing device (e.g., a client device 101A-101N). The example project management user interface 300 depicts a board view in FIGS. 3A and 3B. Although project management user interface 300 is depicted in association with a board view, other project management user interfaces 300 are contemplated including, but not limited to, a backlog view, a deployments view, a road maps view, and/or the like. In a board view of the project management user interface 300, the project management user interface 300 may comprise one or more of work items associated with a current project. For example, the work items may be divided into categories of “To Do”, “In Progress”, “In Review”, and/or “Done”. The work items can be associated with a team (as depicted in FIGS. 3A and 3B, such that the work items are assigned to and/or the responsibility of different team members) or associated with an individual team member.

In some embodiments, the project management user interface 300 comprises a prioritized actionable item insight interface component 400, as depicted in FIG. 3B. Although the prioritized actionable item insight interface component 400 is depicted as being arranged or rendered in a main pane of the project management user interface 300, such depiction is for purposes of illustration and not of limitation and other suitable variations of arranging or rendering the interface components, panes, and panels to the project management user interface 300 are also contemplated by this disclosure as will be apparent to one of ordinary skill in the art. For example, the prioritized actionable item insight interface component 400 may be arranged or caused to be rendered in a sidebar pane of the project management user interface 300. In some embodiments, the project management user interface 300 optionally comprises a selectable insight interface control element 335 as depicted in FIG. 3B and as described herein.

In various embodiments of the present disclosure, an apparatus (e.g., project management server 210 or client device 101A) is configured to generate, output, and/or cause rendering of the prioritized actionable item insight interface component 400 to the project management user interface 300 in a project management and collaboration system 200. Referring now to FIGS. 4A and 4B, an example prioritized actionable item insight interface component 400 structured in accordance with various embodiments of the subject disclosure is illustrated. The prioritized actionable item insight interface component 400 comprises a prioritized actionable item suggestion set, the prioritized actionable item suggestion set listing one or more prioritized actionable items 401A-401N as described herein.

In the non-limiting example depicted in FIG. 4A, the prioritized actionable item insight interface component 400 reflects three prioritized actionable items 401A-401N, but the prioritized actionable item insight interface component 400 can be configured to display any number of prioritized actionable items 401A-401N. With exemplary reference to the first prioritized actionable item depicted in FIG. 4A, each prioritized actionable item of the prioritized actionable item insight interface component 400 may comprise one or more of an actionable item title (“Investigate 2 failed deploys”), an actionable item summary (“Adapt Android app to new payments provider (issue name)”), an actionable item identifier (“CONST-123”), an affected service identifier (“2 production environments”), an embedded link (“Investigate deployment”), and/or the like. In some embodiments, the embedded link(s) provide the user access to the actionable item and/or the underlying software development tool (e.g., Bitbucket®, etc.) associated with the actionable item, enabling the user to be able to review, fix, and/or address the selected prioritized actionable item 401A-401N directly from interaction with the prioritized actionable item insight interface component 400. For example, in response to the user interacting with the embedded link (“Review pull request”) associated with the third prioritized actionable item (“Issue-123”) of FIG. 4A, the computing device 101A-101N may generate and transmit, and the project management server 210 may receive, a request for access to the underlying software development tool. In some embodiments, the project management server 210 is configured to generate and transmit an access module to the project management user interface 300, the access module providing access to the underlying software development tool, such as Bitbucket®, allowing the user to directly interact with and address the actionable item (e.g., approve the pull request).

In still further embodiments, the apparatus (e.g., project management server 210 or client device 101A) is configured to detect a hover user interaction corresponding to at least one of the prioritized actionable items 401A-401N rendered to the prioritized actionable item insight interface component 400 and output an informational interface component 410 associated with the prioritized actionable item 401A-401N corresponding to the detected hover user interaction. For example, as depicted in FIG. 4B, in response to detecting a hover user interaction (e.g., detecting pointer) by the team member in association with the first prioritized actionable item (“Recommended because it affects your assigned issue”), the apparatus outputs an actionable item relationship data object and/or the like, to the informational interface component 410. The actionable item relationship data object identifies at least one factor upon which the corresponding prioritized actionable item 401A-401N was selected for inclusion in the prioritized actionable item suggestion set.

Additionally or alternatively, in some embodiments, the apparatus (e.g., project management server 210) provides for use of a machine learning model designed to leverage artificial intelligence in connection with the determination of a prioritized actionable item suggestion set. For example, in determining the prioritized actionable item suggestion set, the apparatus (e.g., project management server 210) may draw from a range of information sources that can be supplied to the machine learning model in order to make contextual suggestions or predictions as to prioritized actionable items 401A-401N. For example, any one or more of the data described herein (e.g., actionable item data, project data, team member data, and/or the like) and correlations thereof can be used in connection with the machine learning model. For example, in some embodiments, although the varied data outputted in an agile project management environment is not necessarily comparable nor are the key indicators necessarily selectable by a human, the dissimilar aggregate data structure formed from such complex data corpus can be analyzed by the machine learning model to programmatically determine at least the prioritized actionable items and/or the prioritized actionable item suggestion set. In an aspect, the machine learning model thereby informs the prioritized actionable item insight interface component 400, in near real-time, to provide such insight to the user (e.g., team member).

Moreover, in some embodiments, the machine learning based model employed by the apparatus (e.g., project management server 210) can be trained using such actionable item data, project data, team member data, and/or the like. For example, in some embodiments, the apparatus (e.g., via prioritized actionable item insight circuitry 205) implements an unsupervised learning structure, a supervised learning structure, a reinforcement learning structure, a deep learning structure, and/or the like for programmatically determining correlations of the varied data and data formats to make contextual suggestions or predictions as to at least the prioritized actionable items and/or the prioritized actionable item suggestion set.

Still further, in some embodiments, the prioritized actionable item insight interface component 400 may optionally comprise a user feedback engageable element 408. The user feedback engageable element 408 may enable end-users to rate and/or otherwise provide feedback on, for example, the relevancy of a prioritized actionable item and/or a prioritized actionable item suggestion set, and the user-provided ratings may then be used to determine user feedback data objects. In some embodiments, the user feedback data objects are used to retrain and/or continually refine the machine learning model(s).

### Example Operations Performed

Having described example systems and apparatuses and exemplary circuitry in accordance with various embodiments of the present disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof. It will further be appreciated that the example apparatuses, systems, devices, and/or computer program products may proceed to output a prioritized actionable item insight interface component in a project management and collaboration system in a number of ways.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

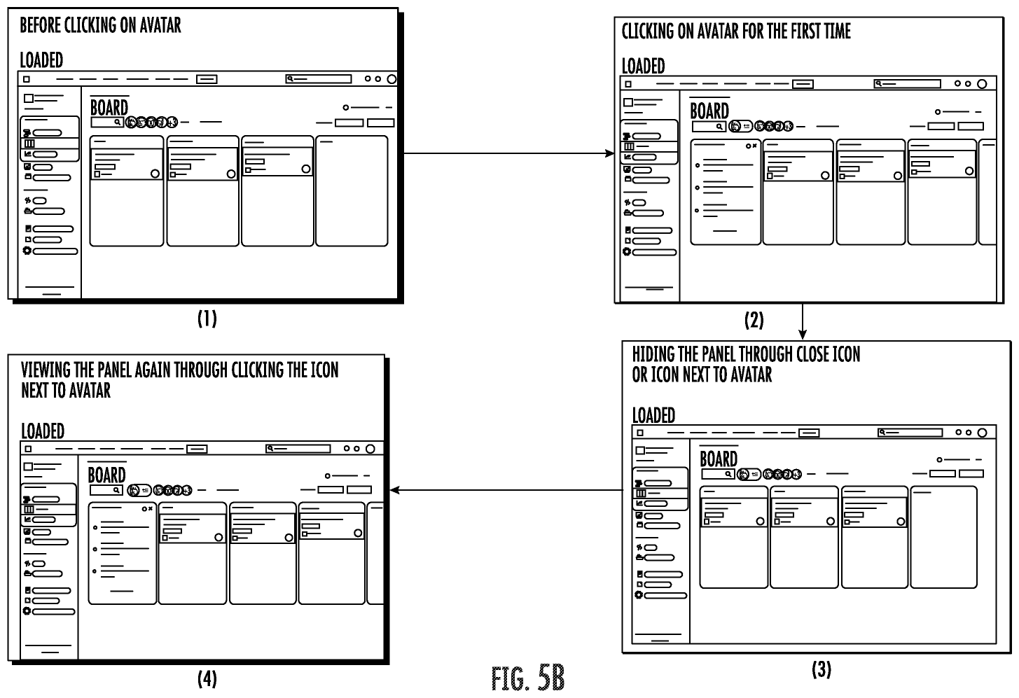

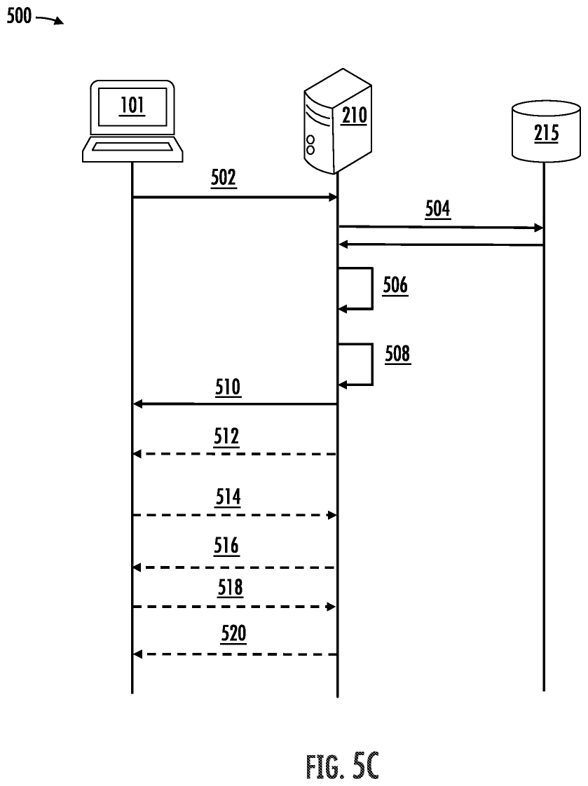

FIG. 5A is a flowchart broadly illustrating a series of operations or process blocks that are executed or performed to output a prioritized actionable item insight interface component in a project management and collaboration system in accordance with some example embodiments of the present disclosure. In some embodiments, the method 500 is embodied by computer program code stored on a non-transitory computer-readable storage medium of a computer program product configured for execution to perform the process as depicted and described. In this regard, in some such embodiments, the project management server 210 is specially configured by computer-coded instructions (e.g., computer program instructions) stored thereon, for example in the memory 201 and/or another component depicted and/or described herein and/or otherwise accessible to the project management server 210, for performing the operations as depicted and described. Alternatively or additionally, in some embodiments, the method 500 is performed by one or more specially configured computing devices, such as the project management server 210 alone or in communication with one or more other component(s), device(s), system(s), and/or the like. For example, in some embodiments, the project management server 210 is in communication with one or more external apparatus(es), system(s), device(s), and/or the like, to perform one or more of the operations as depicted and described. For purposes of simplifying the description, the method 500 is described as performed by and from the perspective of the project management server 210. In this regard, performance of the operations may invoke one or more of memory 201, processor 202, input/output circuitry 203, communications circuitry 204, and/or prioritized actionable item insight circuitry 205.

In the embodiment illustrated in FIG. 5A, the flowchart illustrates method 500 which begins at Block 502. At Block 502, the project management server 210 includes means, such as the memory 201, processor 202, input/output circuitry 203, communications circuitry 204, and/or prioritized actionable item insight circuitry 205, or a combination thereof, to detect a prioritized actionable item insight interface component request. The project management server 210 may detect the prioritized actionable item insight interface component request in any of a myriad of manners. For example, in some embodiments, the prioritized actionable item insight interface component request may be detected in response to user interaction with a project management user interface. For example, the user (e.g., team member, individual contributor, and/or the like) may indicate requested access to the prioritized actionable item insight interface component 400 by verbal command, gesture, on-screen dynamics (e.g., soft key), or other types of input indications that may facilitate generating a prioritized actionable item insight interface component request at the computing device 101A-101N. In one embodiment, an avatar icon associated with the user, an actuator button, and/or other executable interface element is rendered to the project management user interface of the computing device that, when selected by the user, causes the computing device to generate and transmit a prioritized actionable item insight interface component request to the apparatus (e.g., project management server 210). For example, in response to the user clicking or activating the selectable avatar icon rendered to the project management user interface 300 in FIG. 3, the computing device generates and transmits a temporary code representative of a prioritized actionable item insight interface component request to the project management server 210 and the project management server 210 detects such temporary code. Such example, however, is for purposes of illustration and not of limitation and other suitable variations of facilitating the generation of a prioritized actionable item insight interface component request are also contemplated by this disclosure as will be apparent to one of ordinary skill in the art.

In some embodiments, the prioritized actionable item insight interface component request includes a project identifier associated with project information being rendered to the project management user interface. In still further embodiments, the prioritized actionable item insight interface component request includes a team member identifier associated with computing device from which the prioritized actionable item insight interface component request originates. In still further embodiments, the prioritized actionable item insight interface component request includes a team identifier associated with computing device from which the prioritized actionable item insight interface component request originates (e.g., in an instance wherein the prioritized actionable item insight interface component request is associated with a team and/or team leader planning a future sprint in a backlog view of a project management user interface).

At Block 504, the project management server 210 includes means, such as the memory 201, processor 202, input/output circuitry 203, communications circuitry 204, and/or prioritized actionable item insight circuitry 205, or a combination thereof, to access actionable item data. For example, in some embodiments, the project management server 210 queries a repository, such as insight component management repository 215, for actionable item data, using a project identifier and a team member identifier. In still further embodiments, the project management server 210 retrieves one or more candidate actionable items associated with the project identifier and/or the team member identifier. Additionally or alternatively, in other embodiments, the project management server 210 queries the repository using a team identifier and retrieves one or more candidate actionable items associated with the team member identifier (e.g., in an instance wherein the prioritized actionable item insight interface component request is associated with a team and/or team leader planning a future sprint in a backlog view of a project management user interface).

At Block 506, the project management server 210 includes means, such as the memory 201, processor 202, input/output circuitry 203, communications circuitry 204, and/or prioritized actionable item insight circuitry 205, or a combination thereof, to determine a prioritized actionable item suggestion set based at least in part on the actionable item data. In some embodiments, for example when the method 500 does not include Block 504 and/or the querying is not performed in Block 504, the determination of the actionable item suggestion set may comprise querying an insight component management repository based on at least the project identifier and the team member identifier and retrieving one or more candidate actionable items associated with the project identifier and the team member identifier. In some embodiments, the prioritized actionable item suggestion set comprises one or more prioritized actionable items. In some embodiments, the project management server 210 causes storage of the prioritized actionable item suggestion set (e.g., to the insight component management repository 215).

At Block 508, the project management server 210 includes means, such as the memory 201, processor 202, input/output circuitry 203, communications circuitry 204, and/or prioritized actionable item insight circuitry 205, or a combination thereof, to generate a prioritized actionable item insight interface component (e.g., prioritized actionable item insight interface component 400) comprising the prioritized actionable item suggestion set.

At Block 510, the project management server 210 includes means, such as the memory 201, processor 202, input/output circuitry 203, communications circuitry 204, and/or prioritized actionable item insight circuitry 205, or a combination thereof, to output the prioritized actionable item insight interface component for rendering to a project management user interface of a computing device associated with the prioritized actionable item insight interface component request. In the non-limiting example depicted in FIG. 4A, the prioritized actionable item insight interface component 400 reflects three prioritized actionable items, but the prioritized actionable item insight interface component 400 can be configured to display any number of prioritized actionable items. Additionally or alternatively, the project management server 210 may optionally be configured to detect a show more prioritized actionable items request and cause rendering of additional prioritized actionable items of the prioritized actionable item suggestion set to the prioritized actionable item insight interface component.

At Block 512, the project management server 210 includes means, such as the memory 201, processor 202, input/output circuitry 203, communications circuitry 204, and/or prioritized actionable item insight circuitry 205, or a combination thereof, to also optionally cause rendering of one or more selectable insight interface control elements to the project management user interface in response to detecting the prioritized actionable item insight interface component request. Each selectable insight interface control element is configured to enable user control of the prioritized actionable item insight interface component. For example, the icon depicted next to the user avatar in FIG. 3B, and the “x” rendered in the prioritized actionable item insight interface component of FIG. 4A are non-limiting examples of a selectable insight interface control element 335, 435, respectively.

At Block 514, the project management server 210 includes means, such as the memory 201, processor 202, input/output circuitry 203, communications circuitry 204, and/or prioritized actionable item insight circuitry 205, or a combination thereof, to optionally detect a suppress prioritized actionable item insight interface component request. For example, in response to user interaction with the selectable insight interface control element (e.g., the icon next to the user avatar or the “x” rendered in the prioritized actionable item insight interface component as described with respect to Block 512), the computing device may generate and transmit a suppress prioritized actionable item insight interface component request to the project management server 210.

At Block 516, the project management server 210 includes means, such as the memory 201, processor 202, input/output circuitry 203, communications circuitry 204, and/or prioritized actionable item insight circuitry 205, or a combination thereof, to optionally cause stopping of the rendering of the prioritized actionable item insight interface component. For example, as depicted in the third project management user interface of FIG. 5B, the prioritized actionable item insight interface component is no longer rendered (e.g., hidden) to the project management user interface.

At Block 518, the project management server 210 includes means, such as the memory 201, processor 202, input/output circuitry 203, communications circuitry 204, and/or prioritized actionable item insight circuitry 205, or a combination thereof, to optionally detect an expand prioritized actionable item insight interface component request subsequent to causing stopping of the rendering of the prioritized actionable item insight interface component. For example, in response to user interaction with the selectable insight interface control element (e.g., the icon next to the user avatar as described with respect to Block 516), the computing device may generate and transmit an expand prioritized actionable item insight interface component request to the project management server 210.

At Block 520, the project management server 210 includes means, such as the memory 201, processor 202, input/output circuitry 203, communications circuitry 204, and/or prioritized actionable item insight circuitry 205, or a combination thereof, to optionally cause rendering of the prioritized actionable item insight interface component.

FIG. 5B depicts example project management user interfaces illustrating various stages of rendering, suppressing, and expanding a prioritized actionable item insight interface component in a project management user interface in accordance with some example embodiments described herein. In a non-limiting contextual example, a user (e.g., team member) selects their user avatar rendered to the project management user interface on a client device in the first project management user interface depicted in FIG. 5B, the client device generating and transmitting a prioritized actionable item insight interface component request to the project management server 210 in response to such user interaction. In the depicted example, the project management server 210 detects the prioritized actionable item insight interface component request, accesses actionable item data, determines a prioritized actionable item suggestion set based at least in part on the actionable item data, generates a prioritized actionable item insight interface component comprising the prioritized actionable item suggestion set, and outputs the prioritized actionable item insight interface component for rendering to the project management user interface in the second project management user interface depicted in FIG. 5B (corresponding to Blocks 502-510 of method 500). The first project management user interface of FIG. 5B also depicts the result of Block 512 of method 500. In other words, the first project management user interface of FIG. 5B depicts the rendering of selectable insight interface control elements.

Further to the non-limiting contextual example, the user selects or otherwise interacts with one of the selectable insight control elements (e.g., the icon next to the user avatar or the “x” rendered in the prioritized actionable item insight interface component) and the client device generates and transmits a suppress prioritized actionable item insight interface component request that is detected by the project management server. The third project management user interface of FIG. 5B depicts the result of such detected suppress prioritized actionable item insight interface component request in which the project management server causes stopping of the rendering of the prioritized actionable item insight interface component (corresponding to Blocks 514 and 516 of method 500).

Further to the non-limiting contextual example, the user selects or otherwise interacts with the selectable insight interface control element (e.g., the icon next to the user avatar) and the client device generates and transmits an expand prioritized actionable item insight interface component request that is detected by the project management server. The fourth project management user interface in FIG. 5B depicts the result of such detected expand prioritized actionable item insight interface component request in which the project management server again causes the rendering of the prioritized actionable item insight interface component (corresponding to Blocks 518 and 520 of method 500).

FIG. 5C is a signal diagram of an example data flow represented by method 500. That is, FIG. 5C illustrates an example signal diagram illustrating data flow interactions between a project management server, a repository, and a client device when outputting a prioritized actionable item insight interface component in accordance with one embodiment. Method 500 is described as being performed by a client device 101A, a project management server 210, and insight component management repository 215. These may be similar to those previously discussed with regards to FIG. 1.

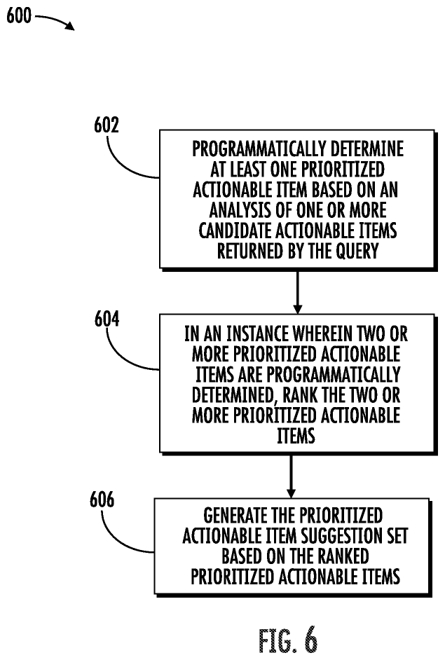

Referring now to FIG. 6, an example method 600 for determining the prioritized actionable item suggestion set is provided. As with FIG. 5A, the operations illustrated in FIG. 6 may, for example, be performed by the project management server 210 which may include means, such as the memory 201, processor 202, input/output circuitry 203, communications circuitry 204, prioritized actionable item insight circuitry 205, or the like, for determining a prioritized actionable item suggestion set.

At Block 602, the project management server 210 includes means, such as the memory 201, processor 202, input/output circuitry 203, communications circuitry 204, and/or prioritized actionable item insight circuitry 205, or a combination thereof, to programmatically determine at least one prioritized actionable item based on an analysis of the one or more candidate actionable items returned by the query (e.g., Block 504). For example, in some embodiments, the project management server 210 (e.g., via the prioritized actionable item insight circuitry 205) may be configured to programmatically determine and/or identify at least one prioritized actionable item based on one or more factors associated with the candidate actionable items, such as available time of the requesting team member, optimal wait time, urgency of the candidate actionable item (e.g., a fast approaching deadline), sprawl of a tool associated with the candidate actionable item, stale feature flag indicator, high profile security vulnerabilities (e.g., linked to issues in an active sprint), a blocked status (e.g., candidate actionable item is associated with a blocked status), a failure status (e.g., failed build and/or deployments associated with current sprint, project, and/or team member), staleness of a candidate actionable item (e.g., carried over from previous sprints too many times), multiple assignees and/or statuses (e.g., actionable item that has been bounced between various statuses and/or assignees), relevance (e.g., surfacing relevant PRs for the team member to review), and/or the like. Additional or alternative factors may include suggestions of trending ideas from Discovery boards, candidate actionable items ready to commence work (e.g., where Design file has been finalized and updated), post-incident actionable items, and minimizing handover time between crafts.

In some embodiments, the project management server 210 programmatically determines the at least one prioritized actionable item at Block 602 via a machine learning model. For example, the varied factors, data, and/or metadata associated with candidate actionable items are not necessarily comparable nor are the key indicators necessarily selectable by a human. Accordingly, such varied factors, data, and/or metadata may be used along with data associated with at least the project identifier, team identifier, and/or the team member identifier, as input for a trained machine learning model, thereby leveraging such artificial intelligence to analyze such dissimilar aggregate of data and output the at least one prioritized actionable item.

At Block 604, the project management server 210 includes means, such as the memory 201, processor 202, input/output circuitry 203, communications circuitry 204, and/or prioritized actionable item insight circuitry 205, or a combination thereof, to, in an instance wherein two or more prioritized actionable items are programmatically determined (e.g., at Block 602), rank the two or more prioritized actionable items. For example, in some embodiments, a prioritized actionable item associated with work that has already been started may be ranked higher than a prioritized actionable item associated with work that is yet to be started. Additionally or alternatively, a prioritized actionable item associated with a high severity level may be ranked higher than a prioritized actionable item associated with a lower severity level. Additional or alternative ranking factors may include, but are not limited to, urgency of the candidate actionable item, engagement factor (e.g., high engagement, such as active comments associated with the actionable item), whether the prioritized actionable item is associated with a service or component causing HOTs or unreliable operations, based on a change management workflow (e.g., approval granted for work to proceed), and/or the like. As with the determination of prioritized actionable items in Block 604, in some embodiments, the project management server 210 may additionally or alternatively programmatically rank prioritized actionable items at Block 604 via a machine learning model.

At Block 606, the project management server 210 includes means, such as the memory 201, processor 202, input/output circuitry 203, communications circuitry 204, and/or prioritized actionable item insight circuitry 205, or a combination thereof, to generate the prioritized actionable item suggestion set based on the ranked prioritized actionable items.

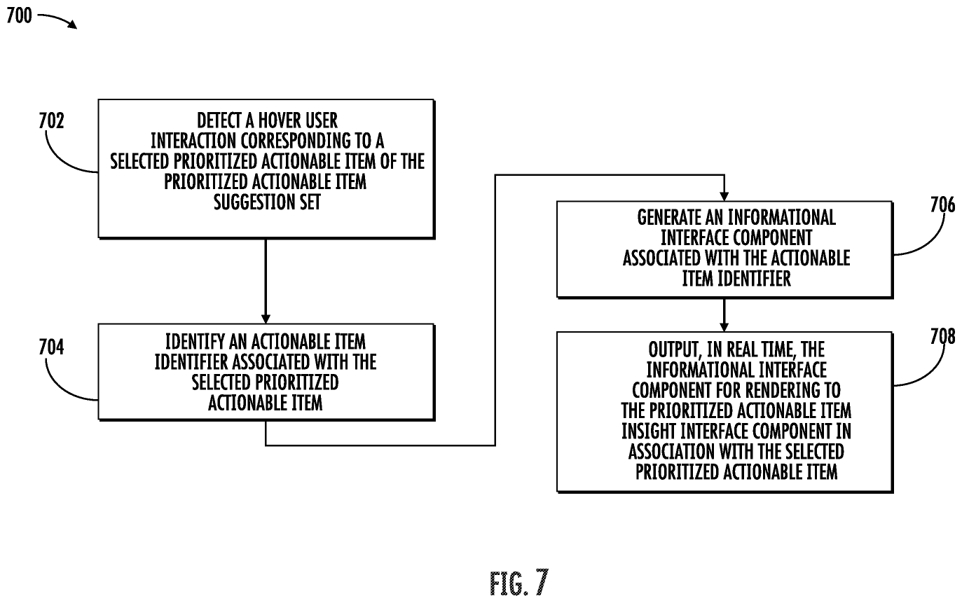

Referring now to FIG. 7, an example method 700 for outputting an informational interface component for rendering to the prioritized actionable item insight interface component is provided. As with FIGS. 5A and 6, the operations illustrated in FIG. 7 may, for example, be performed by the project management server 210 which may include means, such as the memory 201, processor 202, input/output circuitry 203, communications circuitry 204, actionable item insight circuitry 205, or the like, for outputting an informational interface component for rendering.

At Block 702, the project management server 210 includes means, such as the memory 201, processor 202, input/output circuitry 203, communications circuitry 204, and/or prioritized actionable item insight circuitry 205, or a combination thereof, to detect a hover user interaction corresponding to a selected prioritized actionable item of the prioritized actionable item suggestion set rendered to the prioritized actionable item insight interface component.

At Block 704, the project management server 210 includes means, such as the memory 201, processor 202, input/output circuitry 203, communications circuitry 204, and/or prioritized actionable item insight circuitry 205, or a combination thereof, to identify an actionable item identifier associated with the selected prioritized actionable item corresponding to the detected hover user interaction. For example, in some embodiments, each actionable item is associated with a corresponding actionable item and the project management server 210 may identify the corresponding actionable item identifier from the insight component management repository 215.

At Block 706, the project management server 210 includes means, such as the memory 201, processor 202, input/output circuitry 203, communications circuitry 204, and/or prioritized actionable item insight circuitry 205, or a combination thereof, to generate an informational interface component (e.g., informational interface component 410) associated with the actionable item identifier. In some embodiments, the informational interface component comprises an actionable item relationship data object associated with the actionable item identifier. The actionable item relationship data object identifies at least one factor upon which the corresponding prioritized actionable item was selected for inclusion in the prioritized actionable item suggestion set (e.g., as in Block 602). In a non-limiting contextual example, a first factor upon which the corresponding prioritized actionable item was selected for inclusion in the prioritized actionable item suggestion set may be because the actionable item affects an assigned issue associated with the individual contributor or the team. Additionally or alternatively, a second factor upon which the corresponding prioritized actionable item was selected for inclusion in the prioritized actionable item suggestion set may be because the individual contributor (or team) worked on a similar issue in the past.

At Block 708, the project management server 210 includes means, such as the memory 201, processor 202, input/output circuitry 203, communications circuitry 204, and/or prioritized actionable item insight circuitry 205, or a combination thereof, to output, in real time, the informational interface component for rendering to the prioritized actionable item insight interface component in association with the selected prioritized actionable item. For example, as depicted in FIG. 4B, after detecting a hover user interaction (e.g., detecting pointer) by the team member in association with the first prioritized actionable item, the project management server 210 is configured to, inter alia, output the informational interface component associated with the selected prioritized actionable item for rendering to the prioritized actionable item insight interface component. As depicted in FIG. 4B, the informational interface component rendered in real time in association with the first prioritized actionable item comprises the actionable item relationship data object associated with the corresponding actionable item identifier and the team member (“Recommended because it affects your assigned issue”). Non-limiting examples of the actionable item relationship data object may include “Recommended because you were added as a reviewer to this request”, “Recommended because you created this feature flag”, “Recommended because you last worked on this service, and you are the owner of this service”, “Recommended because you have worked on a similar issue in the past”, and/or the like.

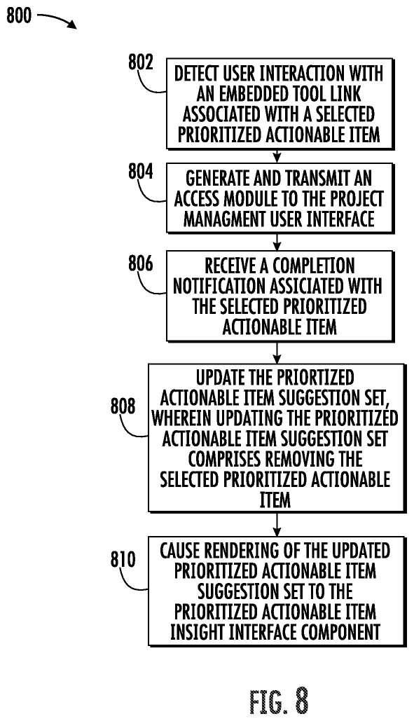

Referring now to FIG. 8, an example method 800 for causing rendering of an updated prioritized actionable item suggestion set to the prioritized actionable item insight interface component is provided. As with FIGS. 5A, 6, and 7, the operations illustrated in FIG. 8 may, for example, be performed by the project management server 210 which may include means, such as the memory 201, processor 202, input/output circuitry 203, communications circuitry 204, actionable item insight circuitry 205, or the like, for causing rendering of an updated prioritized actionable item suggestion set.

At Block 802, the project management server 210 includes means, such as the memory 201, processor 202, input/output circuitry 203, communications circuitry 204, and/or prioritized actionable item insight circuitry 205, or a combination thereof, to detect user interaction with an embedded tool link associated with a selected prioritized actionable item. For example, the user may select the embedded tool link associated with the third prioritized actionable item in FIG. 4A (“Review pull request”).

At Block 804, the project management server 210 includes means, such as the memory 201, processor 202, input/output circuitry 203, communications circuitry 204, and/or prioritized actionable item insight circuitry 205, or a combination thereof, to generate and transmit an access module to the project management user interface 300, the access module providing access to a software development tool (e.g., software development tool 106A-106N) associated with the selected prioritized actionable item. For example, the access module providing access to the underlying software development tool, such as Bitbucket®, may enable the user to directly interact with and address the actionable item (e.g., approve the pull request).

At Block 806, the project management server 210 includes means, such as the memory 201, processor 202, input/output circuitry 203, communications circuitry 204, and/or prioritized actionable item insight circuitry 205, or a combination thereof, to receive a completion notification associated with the selected prioritized actionable item. For example, in a non-limiting contextual example, once the user approves the pull request associated with the third prioritized actionable item in FIG. 4A, the project management server 210 may receive a completion notification from the underlying software development tool (e.g., Bitbucket®) indicating that the selected prioritized actionable item has been handled.

At Block 808, the project management server 210 includes means, such as the memory 201, processor 202, input/output circuitry 203, communications circuitry 204, and/or prioritized actionable item insight circuitry 205, or a combination thereof, to update the prioritized actionable item suggestion set, wherein updating the prioritized actionable item suggestion set comprises removing the selected prioritized actionable item (e.g., the prioritized actionable item associated with the completion notification of Block 806).

At Block 810, the project management server 210 includes means, such as the memory 201, processor 202, input/output circuitry 203, communications circuitry 204, and/or prioritized actionable item insight circuitry 205, or a combination thereof, to cause rendering of the updated prioritized actionable item suggestion set to the prioritized actionable item insight interface component.

FIGS. 5A, 5B, 6, 7, and 8 thus illustrate flowcharts and signal diagrams describing the operation of apparatuses, methods, systems, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 201 of the project management server 210 and executed by a processor 202 of the project management server 210. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

Thus, particular embodiments of the subject matter have been described. While this specification contains many specific implementation details, these should not be construed as limitations on the scope of the present disclosure or of what may be claimed, but rather as description of features specific to particular embodiments of the present disclosure. Other embodiments are within the scope of the following claims. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus for outputting a prioritized actionable item insight interface component to a project management user interface, the apparatus comprising at least one processor, and at least one memory including program code, the at least one memory and the program code configured to, with the at least one processor, cause the apparatus to at least:
detect a prioritized actionable item insight interface component request;
access actionable item data;
determine a prioritized actionable item suggestion set based at least in part on the actionable item data, the prioritized actionable item suggestion set comprising at least one prioritized actionable item;
generate a prioritized actionable item insight interface component comprising the prioritized actionable item suggestion set; and
output the prioritized actionable item insight interface component for rendering to a project management user interface of a computing device associated with the prioritized actionable item insight interface component request.

2. The apparatus of claim 1, wherein the prioritized actionable item insight interface component request is associated with a project identifier and a team member identifier.

3. The apparatus of claim 2, wherein accessing the actionable item data comprises:
querying an insight component management repository based on at least the project identifier and the team member identifier; and
retrieving one or more candidate actionable items associated with the project identifier and the team member identifier.

4. The apparatus of claim 3, wherein determining the prioritized actionable item suggestion set comprises:
programmatically determining the at least one prioritized actionable item based on an analysis of the one or more candidate actionable items returned by the query;
in an instance wherein the query returns two or more prioritized actionable items, ranking the two or more prioritized actionable items; and
generating the prioritized actionable item suggestion set based on the ranked prioritized actionable items.

5. The apparatus of claim 4, wherein programmatically determining the at least one prioritized actionable item is based on a machine learning model.

6. The apparatus of claim 5, wherein the machine learning model is trained using actionable item data.

7. The apparatus of claim 1, wherein the program code is further configured to, with the at least one processor, cause the apparatus to:
detect a hover user interaction corresponding to a selected prioritized actionable item of the prioritized actionable item suggestion set rendered to the prioritized actionable item insight interface component;
identify an actionable item identifier associated with the selected prioritized actionable item corresponding to the detected hover user interaction;
generate an informational interface component associated with the actionable item identifier, wherein the informational interface component comprises an actionable item relationship data object associated with the actionable item identifier; and
output the informational interface component for rendering to the prioritized actionable item insight interface component in association with the selected prioritized actionable item in real time.

8. The apparatus of claim 1, wherein detecting the prioritized actionable item insight interface component request is in response to user interaction with the project management user interface.

9. The apparatus of claim 1, wherein the program code is further configured to, with the at least one processor, cause the apparatus to:
cause rendering of a selectable insight interface control elements to the project management user interface, wherein the selectable insight interface control elements is configured for enabling user control of the prioritized actionable item insight interface component.

10. The apparatus of claim 9, wherein the program code is further configured to, with the at least one processor, cause the apparatus to:
detect a suppress prioritized actionable item insight interface component request; and
cause stopping of the rendering of the prioritized actionable item insight interface component.

11. The apparatus of claim 10, wherein the program code is further configured to, with the at least one processor, cause the apparatus to:
detect an expand prioritized actionable item insight interface component request subsequent to causing stopping of the rendering of the prioritized actionable item insight interface component; and
cause rendering of the prioritized actionable item insight interface component.

12. The apparatus of claim 1, wherein the program code is further configured to, with the at least one processor, cause the apparatus to:
detect user interaction with an embedded tool link associated with a selected prioritized actionable item; and
generate and transmit an access module to the project management user interface, the access module providing access to a software development tool associated with the selected prioritized actionable item.

13. The apparatus of claim 12, wherein the program code is further configured to, with the at least one processor, cause the apparatus to:
receive a completion notification associated with the selected prioritized actionable item;
update the prioritized actionable item suggestion set, wherein updating the prioritized actionable suggestion set comprises removing the selected prioritized actionable item; and
cause rendering of the updated prioritized actionable item suggestion set to the prioritized actionable item insight interface component.

14. The apparatus of claim 1, wherein the program code is further configured to, with the at least one processor, cause the apparatus to:
detect a show more prioritized actionable items request; and
cause rendering of additional prioritized actionable items of the prioritized actionable item suggestion set to the prioritized actionable item insight interface component.

15. A method for outputting a prioritized actionable item insight interface component to a project management user interface, the method comprising:
detecting a prioritized actionable item insight interface component request;
determining a prioritized actionable item suggestion set;
generating a prioritized actionable item insight interface component comprising the prioritized actionable item suggestion set; and
outputting the prioritized actionable item insight interface component for rendering to a project management user interface of a computing device associated with the prioritized actionable item insight interface component request.

16. The method of claim 15, wherein the prioritized actionable item insight interface component request is associated with a project identifier and a team member identifier, and wherein determining a prioritized actionable item suggestion set comprises:
querying an insight component management repository based on at least the project identifier and the team member identifier; and
retrieving one or more candidate actionable items associated with the project identifier and the team member identifier.

17. The method of claim 16, wherein determining the prioritized actionable item suggestion set comprises:
programmatically determining at least one prioritized actionable item based on an analysis of the one or more candidate actionable items returned by the query;
in an instance wherein the query returns two or more prioritized actionable items, ranking the two or more prioritized actionable items; and
generating the prioritized actionable item suggestion set based on the ranked prioritized actionable items.

18. The method of claim 15, further comprising:
detecting a hover user interaction corresponding to a selected prioritized actionable item of the prioritized actionable item suggestion set rendered to the prioritized actionable item insight interface component;
identifying an actionable item identifier associated with the selected prioritized actionable item corresponding to the detected hover user interaction;
generating an informational interface component associated with the actionable item identifier, wherein the informational interface component comprises an actionable item relationship data object associated with the actionable item identifier; and
outputting the informational interface component for rendering to the prioritized actionable item insight interface component in association with the selected prioritized actionable item in real time.

19. The method of claim 15, further comprising:
detecting user interaction with an embedded tool link associated with a selected prioritized actionable item;
generating and transmitting an access module to the project management user interface, the access module providing access to a software development tool associated with the selected prioritized actionable item;
receiving a completion notification associated with the selected prioritized actionable item;
updating the prioritized actionable item suggestion set, wherein updating the prioritized actionable suggestion set comprises removing the selected prioritized actionable item; and
rendering the updated prioritized actionable item suggestion set to the prioritized actionable item insight interface component.

20. A computer program product for outputting a prioritized actionable item insight interface component to a project management user interface, the computer program product comprising at least one non-transitory computer-readable storage medium having computer-readable program code portions stored therein, the computer-readable program code portions comprising an executable portion configured to:
determine a prioritized actionable item suggestion set based at least in part on a detected prioritized actionable item insight interface component request, the prioritized actionable item suggestion set comprising at least one prioritized actionable item;
generate a prioritized actionable item insight interface component comprising the prioritized actionable item suggestion set; and
output the prioritized actionable item insight interface component for rendering to a project management user interface of a computing device associated with the detected prioritized actionable item insight interface component request.
